(19) United States
(12) Patent Application Publication
(10) Pub. No.: US 2013/0204602 A1
(43) Pub. Date: Aug. 8, 2013

(54) SIMULATION APPARATUS AND METHOD FOR VERIFYING HYBRID SYSTEM

(71) Applicant: Electronics and Telecommunications Research Institute, Daejeon-city (KR)

(72) Inventors: Jin-Myoung Kim, Daejeon (KR); In-Geol Chun, Seoul (KR); Won-Tae Kim, Asan (KR); Seung-Min Park, Daejeon (KR)

(73) Assignee: Electronics and Telecommunications Research Institute, Daejeon-city (KR)

(21) Appl. No.: 13/759,339

(22) Filed: Feb. 5, 2013

(30) Foreign Application Priority Data
Feb. 7, 2012 (KR) 10-2012-0012365

(51) Int. Cl. G06F 17/50

(52) U.S. Cl. CPC G06F 17/5009
USPC 703/21

(57) ABSTRACT

Disclosed herein is a simulation apparatus for verifying a hybrid system. The simulation apparatus includes a system model input unit, a model information storage unit, a simulation unit, and a result display unit. The system model input unit receives subsystem models which model subsystems included in a hybrid system. The model information storage unit stores the subsystem models and information about the operations of the subsystem models. The simulation unit runs a simulation of the subsystem models based on the information about the operations of the subsystem models stored in the model information storage unit. The result display unit displays the results of running the simulation of the subsystem models using the simulation unit.

### CROSS-REFERENCE TO RELATED APPLICATION

This application claims the benefit of Korean Patent Application No. 10-2012-0012365, filed on Feb. 7, 2012, which is hereby incorporated by reference in its entirety into this application.

### BACKGROUND OF THE INVENTION

1. Technical Field

The present invention relates generally to a simulation apparatus and method for verifying the reliability of a hybrid system. In particular, the present invention related to a simulation apparatus and method for verifying the reliability of a hybrid system, which in a process in a developer designs a hybrid system such as a virtual physical system, dynamically load models of the designed hybrid system into a simulator and display the results of simulation, thereby enabling the developer to check the reliability of the designed hybrid system.

2. Description of the Related Art

A Cyber Physical System (CPS) is a system which guarantees the reliability, real-time feature and intelligence of software in order to prevent unexpected errors and situations from arising because a real-world system is combined with a computing system, thereby increasing complexity. A CPS is a hybrid system in which a plurality of embedded systems is combined based on a network, and has both features of physical and computational elements.

Simulation technologies have been widely used as an aid in designing a single system during a process of developing an embedded system that requires high reliability. First, modeling is performed which represents a system to be developed using an abstract model. Thereafter, the system model is verified and modified by running a simulation using the system model. After the verification has been completed, actual hardware or software is developed based on the model. The advantage of performing verification using a simulation is that a system with reliability can be developed with the cost and danger accompanying the actual development and verification of a system reduced.

Conventional simulation technologies which are used to ensure the validity of an embedded system model provide a Hardware-in-the-Loop functionality or a Software-in-the-Loop technology which enables a simulation to be run with actual hardware or software substituted for some modules of the model of a single system. Representatives of products which provide such technologies include MATLAB/Simulink, LabVIEW, and Saber. Such technologies provide the input of an actual system to a model, thereby increasing the effectiveness of verification using simulation.

However, the conventional simulation technologies are intended for the simulation of a single system which is used to develop a single embedded system. Accordingly, the conventional simulation technologies are not suitable for the simulation of a large-scale hybrid system, such as a virtual physical system, including a variety of types of heterogeneous embedded systems. Furthermore, when the design of a system model is changed, it is cumbersome to reconfigure a simulator in order to run a simulation of the changed system model. Moreover, it is difficult to determine the complexity of a model when it is requested that a system operate in real time.

### SUMMARY OF THE INVENTION

Accordingly, the present invention has been made keeping in mind the above problems occurring in the prior art, and an object of the present invention is to provide a technology which dynamically loads a hybrid system model designed by a developer into a simulator and runs a simulation, so that a simulation of a changed system model can be run in a flexible manner even when the hybrid system model is frequently changed because the developer redesigns a system.

Another object of the present invention is to provide a technology which evaluates the real-time features of subsystem models included in a designed hybrid system, so that the optimal simulation speed required to verify the reliability of the system can be determined, and so that subsystem models of the hybrid system which need to be improved to achieve the real-time operation can be found.

In order to accomplish the above objects, the present invention provides a simulation apparatus for verifying a hybrid system, including a system model input unit for receiving subsystem models which model subsystems included in a hybrid system; a model information storage unit for storing the subsystem models and information about the operations of the subsystem models; a simulation unit for running a simulation of the subsystem models based on the information about the operations of the subsystem models stored in the model information storage unit; and a result display unit for displaying the results of running the simulation of the subsystem models using the simulation unit.

Here, the simulation unit may include a simulation speed setting unit for setting the speed of the simulation of the subsystem models by analyzing the real-time features of the respective subsystem models.

Here, the simulation speed setting unit may set the speed of the simulation of the subsystem models to a speed at which all the subsystem models can operate.

Here, the simulation unit may further include a simulation speed adjustment unit for, when it is requested that the simulation speed be changed, changing the speed of the simulation of the subsystem models to a requested simulation speed.

Here, the simulation unit may further include a simulation execution unit for running the simulation of the subsystem models based on the simulation speed which was set using the simulation speed setting unit or which was changed using the simulation speed adjustment unit

Here, the simulation unit may further include a model loading unit for dynamically loading the subsystem models into the simulation execution unit.

In order to accomplish the above objects, the present invention provides a simulation method for verifying a hybrid system, including receiving subsystem models which model subsystems included in a hybrid system; dynamically loading the subsystem models in order to run a simulation; setting a simulation speed by analyzing the real-time features of the respective subsystem models; running the simulation of the subsystem models at the set simulation speed based on information about the operations of the subsystem models; and displaying the results of running the simulation of the subsystem models.

Here, the setting the simulation speed by analyzing the real-time features of the respective subsystem models may include setting the simulation speed of the subsystem models to a speed at which all the subsystem models can operate.

Here, the running the simulation of the subsystem models may include starting to run the simulation of the subsystem models at the set simulation speed; determining whether it is requested that the simulation speed of the subsystem models be changed; and, if it has been requested that the simulation speed of the subsystem models be changed, changing the simulation speed of the subsystem models at a requested simulation speed and then running the simulation of the subsystem models.

Here, the simulation method may further include storing the subsystem models and the information about the operations of the subsystem models.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a simulation apparatus for verifying a hybrid system according to the present invention;

FIG. 2 is a block diagram illustrating the configuration of a simulation unit shown in FIG. 1; and

FIGS. 3 and 4 are flowcharts illustrating a simulation method for verifying the hybrid system according to the present invention.

### DESCRIPTION OF THE PREFERRED EMBODIMENTS

The present invention will be described below in detail with reference to the accompanying drawings. Here, repetitive descriptions and detailed descriptions of well-known functions or configurations which would unnecessarily obscure the gist of the present invention will be omitted. Embodiments of the present invention are provided to complete the explanation for those skilled in the art of the present invention. Therefore, the shapes and sizes of components in the drawings may be exaggerated to provide more precise descriptions.

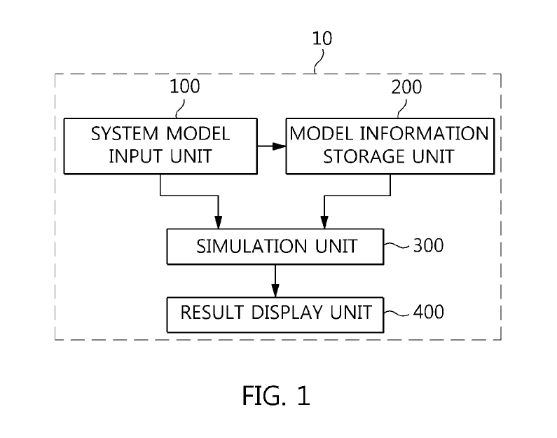

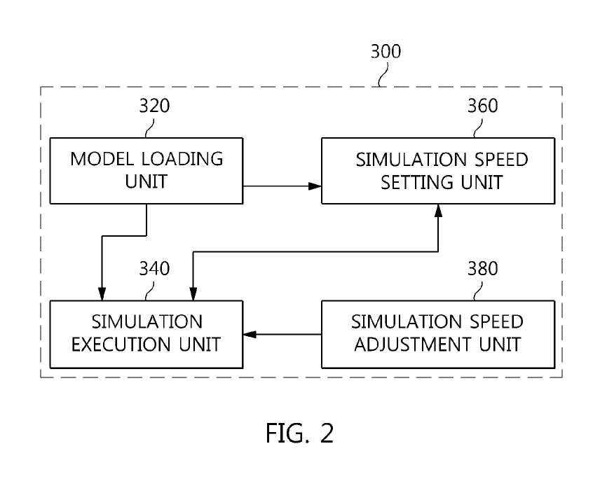

The configuration and operation of a simulation apparatus for verifying a hybrid system according to the present invention will be described below with reference to FIGS. 1 and 2.

FIG. 1 is a block diagram illustrating the configuration of the simulation apparatus for verifying the hybrid system according to the present invention.

Referring to FIG. 1, a simulation apparatus 10 for verifying a hybrid system according to the present invention includes a system model input unit 100, a model information storage unit 200, a simulation unit 300, and a result display unit 400.

The system model input unit 100 receives models which model subsystems included in a hybrid system (hereinafter referred to as “subsystem models”) from the outside. When the developer of a hybrid system analyzes the requirements of a system and designs the system based on the results of the analysis, the developer verifies the designed system by running a simulation in order to predict problems which may occur in the designed system and remove the problems. In order to run the simulation on the system in the design stage, the developer designs a model-based hybrid system using a general system modeler, in which case the system model input unit 100 receives subsystem models which model subsystems included in the hybrid system from the developer. Here, the subsystem models which are input to the system model input unit 100 may be constructed based on Unified Modeling Language (UML) which has been generally used to model a system.

The model information storage unit 200 stores the subsystem models of the hybrid system, which have been input to the system model input unit 100 by the developer, and information about the operations of the respective subsystem models. The information about the operations of the respective subsystem models, which is stored in the model information storage unit 200, may include information about the interrelationship between the operations of the subsystem models. If it is requested by the developer that a simulation of the modeled hybrid system be run, the model information storage unit 200 provides the stored subsystem models and the information about the operations of the respective subsystem models to the simulation unit 300.

The simulation unit 300 runs a simulation of the subsystem models using the information about the operations of the respective subsystem models of the hybrid system, which is stored in the model information storage unit 200.

Referring to FIG. 2, the simulation unit 300 may include a model loading unit 320, a simulation execution unit 340, a simulation speed setting unit 360, and a simulation speed adjustment unit 380.

The model loading unit 320 dynamically loads the subsystem models into the simulation execution unit 340 so that the simulation of the designed hybrid system can be run. That is, when it is requested by the developer that a simulation of the modeled hybrid system be run, the model loading unit 320 dynamically loads the subsystem models stored in the model information storage unit 200 into the simulation execution unit 340 so that the simulation execution unit 340 runs the simulation of the subsystem models. In accordance with the present invention, the model loading unit 320 dynamically loads the subsystem models into the simulation execution unit 340 which actually runs the simulation, so that, even if the hybrid system model is frequently changed because the developer redesigns the hybrid system, the simulation of the system can be run with flexibility.

The simulation execution unit 340 runs the simulation of the subsystem models, loaded by the model loading unit 320, using the information about the operations of the respective subsystem models which has been provided from the model information storage unit 200. Physical elements and computational elements are present at the same time in a hybrid system such as a virtual physical system, and therefore the subsystem models of the hybrid system, which are designed by the developer and input to the system model input unit 100, correspond to continuous system models or discrete system models. Therefore, the simulation execution unit 340 provides a function of running a simulation of the hybrid system models which include both continuous system models and discrete system models. Since the simulation of the hybrid system model run by the simulation execution unit 340 according to the present invention uses a general simulation method using a continuous system simulator and a discrete system simulator, known from U.S. Patent Application Publication No. 2010/0250226A1, a detailed description thereof is omitted.

Here, the simulation execution unit 340 first starts running the simulation of the subsystem models at a simulation speed set by the simulation speed setting unit 360. If during the running of the simulation of the subsystem models, it is requested that the simulation speed be changed by another external simulator or developer in a distributed environment, the simulation execution unit 340 runs the simulation of the subsystem models at a simulation speed changed by the simulation speed adjustment unit 380. A description will be given below of how the simulation speed setting unit 360 sets the simulation speed and how the simulation speed adjustment unit 380 changes the simulation speed.

The simulation speed setting unit 360 sets the simulation speed for the subsystem models by analyzing the real-time feature of each of the subsystem models, loaded into the simulation execution unit 340, using the model loading unit 320. Here, it is preferable that the simulation speed setting unit 360 set the simulation speed to a speed at which all the subsystem models can operate. Here, the simulation speed setting unit 360 evaluates the real-time feature of each of the subsystem models using a source code analysis process in which the source code of each of the subsystem models written by the developer is analyzed and the results of the analysis are used as basic information for real-time feature analysis, and using a static analysis process in which the results of the analysis obtained in the source code analysis process are combined with an execution embedded environment and the results of the combination are analyzed, thereby recognizing real-time features. The simulation speed setting unit 360 sets the simulation speed after taking into consideration the evaluated real-time feature of each of the subsystem models. Thereafter, the simulation speed setting unit 360 provides the set simulation speed to the simulation execution unit 340. Here, the evaluation of the real-time feature of each of the subsystem models, which has been performed by the simulation speed setting unit 360, enables the developer to detect a subsystem model which has a problem with a real-time feature in the hybrid system designed by the developer in the early stages. Accordingly, the evaluation can be used as an index which enables the degree of abstraction of the model designed by the developer to be determined.

If during the running of the simulation by the simulation execution unit 340, it is requested by another external simulator or the developer that the simulation speed be changed in the distributed environment, the simulation speed adjustment unit 380 changes the speed of the simulation of the subsystem models, run by the simulation execution unit 340, to the requested simulation speed. Accordingly, the simulation speed adjustment unit 380 provides the function of enabling the speed of the simulation of the hybrid system to be compulsorily changed in the distributed environment, thereby enabling the simulation to be performed more quickly. Here, the simulation speed adjustment unit 380 can determine whether to change the simulation speed by determining whether the simulation of the subsystem models can be run at the speed which is requested from the outside.

The result display unit 400 outputs the results of running the simulation of the subsystem models using the simulation unit 300 to the outside. That is, the result display unit 400 displays the results of the simulation unit 300 running the simulation in real time using display means so that the developer who designed the hybrid system can check the reliability of the system he or she designed. Here, as the display means used to display the results of running the simulation, all display means, such as a Liquid Crystal Display (LCD), a Plasma Display Panel (PDP), and a touch screen, which are generally used may be used.

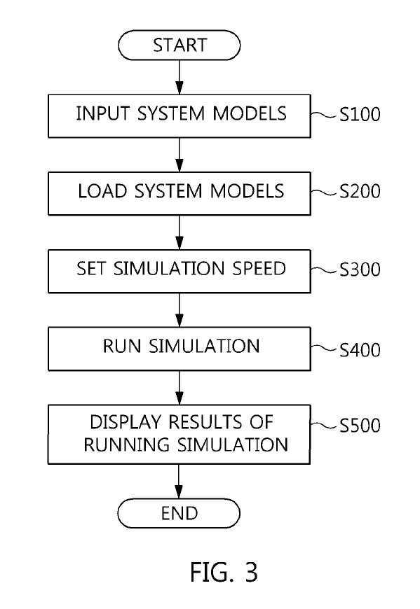

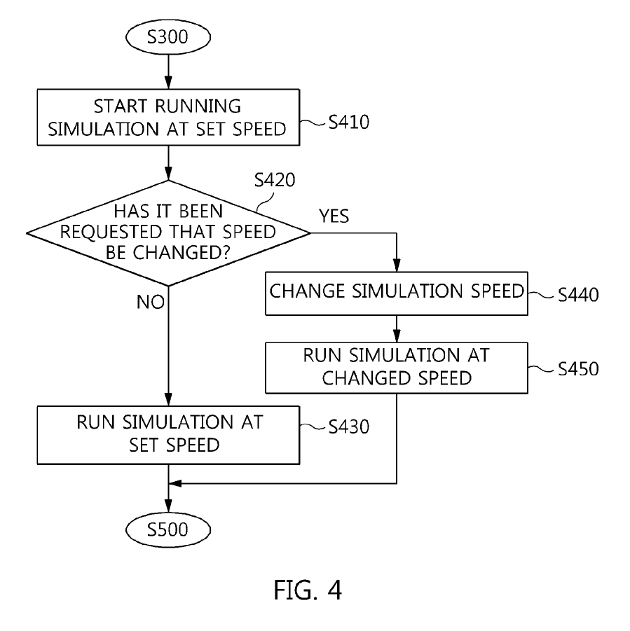

A simulation method for verifying a hybrid system according to the present invention will now be described with reference to FIGS. 3 and 4. Descriptions which are identical to those of the operation of the simulation apparatus for verifying a hybrid system according to the present invention which have already been given in conjunction with FIGS. 1 and 2 will be omitted.

FIG. 3 is a flowchart illustrating the simulation method for verifying a hybrid system according to the present invention.

Referring to FIG. 3, in the simulation method for verifying a hybrid system according to the present invention, first, the system model input unit receives subsystem models which model subsystems included in a hybrid system at step S100. Here, the model information storage unit stores the subsystem models which were input to the system model input unit and information about the operations of the respective subsystem models.

Thereafter, the model loading unit of the simulation unit dynamically loads the subsystem models which were stored in the model information storage unit into the simulation execution unit at step S200.

Thereafter, the simulation speed setting unit sets the simulation speed of the subsystem models by analyzing the real-time feature of each of the subsystem models which were loaded into the simulation execution unit by the model loading unit at step S300. Here, the simulation speed setting unit sets the simulation speed of the subsystem models to a speed at which all the subsystem models can operate.

Thereafter, the simulation execution unit simulates the subsystem models, dynamically loaded by the model loading unit, using the information about the operations of the subsystem models which was stored in the model information storage unit at step S400.

Finally, the result display unit displays the results of the simulation execution unit running the simulation of the subsystem models to the outside at step S500.

FIG. 4 is a flowchart illustrating step S400 of the flowchart of FIG. 3 illustrating the simulation method for verifying a hybrid system according to the present invention shown in greater detail.

Referring to FIG. 4, at step S400 at which the simulation execution unit runs the simulation of the subsystem models using the information about the operations of the subsystem models, the simulation execution unit first starts running the simulation of the subsystem models at the simulation speed set by the simulation speed setting unit at step S410.

Thereafter, the simulation speed adjustment unit determines whether it is requested that the simulation speed of the subsystem models be changed at step S420. That is, the simulation speed adjustment unit determines whether during the running of the simulation by the simulation execution unit, another external simulator or the developer has requested that the simulation speed be changed in the distributed environment.

If, as a result of the determination at step S420, it has not been requested that the simulation speed be changed, the simulation execution unit continues to run the simulation of the subsystem models at the simulation speed which was set by the simulation speed setting unit at step S430.

Meanwhile, at step S450, if, as the result of the determination at step S420, it has been requested that the simulation speed be changed, the simulation speed adjustment unit changes the simulation speed of the subsystem models to the requested simulation speed at step S440, and the simulation execution unit runs the simulation of the subsystem models at the simulation speed which was changed at step S440.

According to the present invention, when the developer wants to design a hybrid system such as a virtual physical system, a simulation of system models is run in order to guarantee the reliability of the system, so that there is the advantage of easily verifying whether the designed hybrid system is configured as the developer had planed.

Furthermore, according to the present invention, each of subsystem models included in a hybrid system is dynamically loaded into a simulator, so that there is an advantage in that a simulation of the designed hybrid system can be run with flexibility even when some of the subsystem models are changed by a developer.

Moreover, according to the present invention, the real-time feature of each of subsystem models included in a hybrid system is evaluated, so that there are the advantage of easily determining subsystems to be abstracted from among the subsystems included in the system and the advantage of determining the optimal simulation time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A simulation apparatus for verifying a hybrid system, comprising:
a system model input unit for receiving subsystem models which model subsystems included in a hybrid system;
a model information storage unit for storing the subsystem models and information about operations of the subsystem models;
a simulation unit for running a simulation of the subsystem models based on the information about the operations of the subsystem models stored in the model information storage unit; and
a result display unit for displaying results of running the simulation of the subsystem models using the simulation unit.

2. The simulation apparatus as set forth in claim 1, wherein the simulation unit comprises a simulation speed setting unit for setting a speed of the simulation of the subsystem models by analyzing real-time features of the respective subsystem models.

3. The simulation apparatus as set forth in claim 2, wherein the simulation speed setting unit sets the speed of the simulation of the subsystem models to a speed at which all the subsystem models can operate.

4. The simulation apparatus as set forth in claim 2, wherein the simulation unit further comprises a simulation speed adjustment unit for, when it is requested that the simulation speed be changed, changing the speed of the simulation of the subsystem models to a requested simulation speed.

5. The simulation apparatus as set forth in claim 4, wherein the simulation unit further comprises a simulation execution unit for running the simulation of the subsystem models based on the simulation speed which is set by the simulation speed setting unit or which is changed by the simulation speed adjustment unit.

6. The simulation apparatus as set forth in claim 5, wherein the simulation unit further comprises a model loading unit for dynamically loading the subsystem models into the simulation execution unit.

7. A simulation method for verifying a hybrid system, comprising:
receiving subsystem models which model subsystems included in a hybrid system;
dynamically loading the subsystem models in order to run a simulation;
setting a simulation speed by analyzing real-time features of the respective subsystem models;
running the simulation of the subsystem models at the set simulation speed based on information about operations of the subsystem models; and
displaying results of running the simulation of the subsystem models.

8. The simulation method as set forth in claim 7, wherein the setting the simulation speed by analyzing the real-time features of the respective subsystem models comprises setting the simulation speed of the subsystem models to a speed at which all the subsystem models can operate.

9. The simulation method as set forth in claim 7, wherein the running the simulation of the subsystem models comprises:
starting to run the simulation of the subsystem models at the set simulation speed;
determining whether it is requested that the simulation speed of the subsystem models be changed; and
if it has been requested that the simulation speed of the subsystem models be changed, changing the simulation speed of the subsystem models to a requested simulation speed and then running the simulation of the subsystem models.

10. The simulation method as set forth in claim 7, further comprising storing the subsystem models and the information about the operations of the subsystem models.
